(19) United States
(12) Patent Application Publication
(10) Pub. No.: US 2020/0036794 A1
(43) Pub. Date: Jan. 30, 2020

(54) REMOTE CONTROL METHOD AND APPARATUS FOR SMART DEVICE AND READABLE STORAGE MEDIUM

(71) Applicant: BEIJING XIAOMI MOBILE SOFTWARE CO., LTD., Beijing (CN)

(72) Inventor: Yongli SUN, Beijing (CN)

(73) Assignee: BEIJING XIAOMI MOBILE SOFTWARE CO., LTD., Beijing (CN)

(21) Appl. No.: 16/427,255

(22) Filed: May 30, 2019

(30) Foreign Application Priority Data
Jul. 26, 2018 (CN) 201810832170.4

(51) Int. Cl. H04L 29/08; H04L 12/28

(52) U.S. Cl. CPC H04L 67/125; H04L 12/282

(57) ABSTRACT

A remote control method and apparatus for a smart device and a readable storage medium are provided. In the present disclosure, for the received first control signaling sent by the control terminal, when the first state parameter indicated by the first control signaling is different from the locally stored current state parameter that the smart device corresponds to, the second control signaling is sent to the smart device to control the smart device to change its current state, instead of having to send the second control signaling every time the first control signaling is received, thereby effectively reducing the network overhead of signaling transmission.

### CROSS-REFERENCE TO RELATED APPLICATION

This application is based upon and claims priority to Chinese Patent Application No.: 201810832170.4, filed Jul. 26, 2018, the entire contents of which are incorporated herein by reference.

### TECHNICAL FIELD

The present disclosure relates to the field of computer technology, and more particularly, to a remote control method and apparatus for a smart device and a readable storage medium.

### BACKGROUND

As the concept of smart home is becoming more and more popular, it is gradually populated that user purchases and uses smart devices. The user can control the smart device with traditional keys and may also remotely control the smart device through a control terminal.

In the related art, when the user remotely controls the smart device through the control terminal, the control terminal sends a control terminal instruction to a server. The server processes the control terminal instruction to obtain a server instruction. The server establishes communication with the smart device and sends the server instruction to the smart device. The smart device receives and executes the server instruction.

By adopting the remote control method in the related art, each time the server receives the control terminal instruction sent by the control terminal, the server needs to establish the connection communication with the smart device and send the corresponding server instruction, which will waste network traffic overhead.

### SUMMARY

The present disclosure provides a remote control method and apparatus for a smart device and a readable storage medium. The technical solutions are as follow.

According to a first aspect of the present disclosure, there is provided a remote control method for a smart device, including: receiving first control signaling sent by a control terminal for controlling the smart device, wherein the smart device is a device bound to the control terminal; acquiring a first state parameter indicated by the first control signaling, and acquiring, according to the first control signaling, a locally stored current state parameter that the smart device corresponds to; and sending second control signaling to the smart device when the first state parameter is different from the current state parameter, wherein the second control signaling includes a second state parameter for controlling the smart device to change a current state.

According to a second aspect of the present disclosure, there is provided a remote control method for a smart device, including: receiving second control signaling sent by a server, wherein the second control signaling includes a second state parameter for controlling the smart device to change the current state, the second control signaling is sent when the server receives the first control signaling sent by the control terminal and the first state parameter indicated by the first control signaling is different from the current state parameter that the smart device corresponds to, wherein the current state parameter is the state parameter is locally stored in the server and the smart device corresponds to, and the smart device is a device bound to the control terminal; and updating the current state based on the second state parameter.

According to a third aspect of the present disclosure, there is provided a remote control apparatus for a smart device, including: a first receiving module configured to receive first control signaling to control the smart device, wherein the smart device is a device bound to the control terminal; a first acquiring module configured to acquire a first state parameter indicated by the first control signaling, and acquire, according to the first control signaling, a locally stored current state parameter that the smart device corresponds to; and a first sending module configured to send second control signaling to the smart device when the first state parameter is different from the current state parameter, wherein the second control signaling includes a second state parameter for controlling the smart device to change the current state.

According to a fourth aspect of the present disclosure, there is provided a remote control apparatus for a smart device, including: a third receiving module configured to receive second control signaling sent by a server, wherein the second control signaling includes a second state parameter for controlling the smart device to change the current state, the second control signaling is sent when the server receives the first control signaling sent by the control terminal and a first state parameter indicated by the first control signaling is different from the current state parameter that the smart device corresponds to, wherein the current state parameter is the state parameter locally stored in the server and corresponding to the smart device, and the smart device is a device bound to the control terminal; and a third updating module configured to update the current state based on the second state parameter.

According to a fifth aspect of the present disclosure, there is provided a remote control apparatus for a smart device, including: a processor; and a memory for storing executable instructions for the processor; wherein the processor is configured to implement steps of any one of the methods in the first aspect.

According to a sixth aspect of the present disclosure, there is provided a computer-readable storage medium, wherein instructions are stored, to implement steps of any one of the methods in the first aspect when the instructions are executed by the processor.

It is understood that both the foregoing general description and the following detailed description are exemplary only and will not limit the present disclosure.

### BRIEF DESCRIPTION OF THE DRAWINGS

The accompanying drawings, which are incorporated in and constitute a part of this specification, illustrate the embodiments that meets the present disclosure and, together with the specification, are used to explain the principles of the present disclosure.

FIG. 1 shows an architectural diagram of a remote control system for a smart device according to an aspect of the present disclosure;

FIG. 2 shows a flowchart of a remote control method for a smart device according to an aspect of the present disclosure;

FIG. 3 shows a flowchart of a remote control method for a smart device according to an aspect of the present disclosure;

FIG. 4 shows a flowchart of a remote control method for a smart device according to an aspect of the present disclosure;

FIG. 5 shows a block diagram of a structure of a remote control apparatus for a smart device according to an aspect of the present disclosure;

FIG. 6 shows a block diagram of a structure of a remote control apparatus for a smart device according to an aspect of the present disclosure;

FIG. 7 shows a block diagram of a structure of a remote control apparatus for a smart device according to an aspect of the present disclosure; and

FIG, 8 shows a block diagram of a structure of a remote control apparatus for a smart device according to an aspect of the present disclosure.

### DETAILED DESCRIPTION

In order to more clarify the objectives, technical solutions and advantages of the present disclosure, the embodiments of the present disclosure will be further described in detail below with reference to the accompanying drawings.

Prior to the detailed explanation of the present disclosure, the application scenarios and related technologies involved in the present disclosure will be described first.

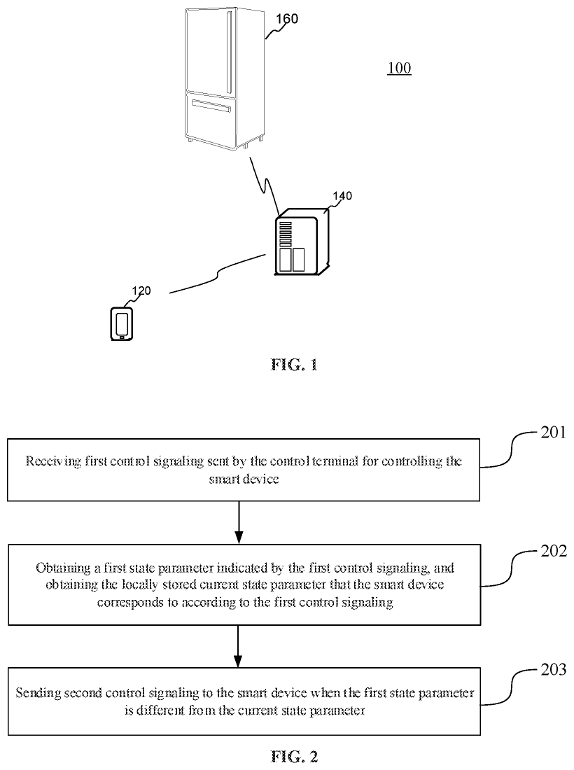

FIG. 1 shows an architectural diagram of a remote control system 100 for a smart device provided by an aspect of the present disclosure. The system 100 includes at least one smart device 120, at least one server 140, and at least one control terminal 160.

The smart device 120 may be a smart device such as a smart home appliance, a personal user entertainment terminal, or a smart door or window that can be remotely controlled through network connection and has the capability of network communication. The smart device 120 has different states during operation, for example, the on/off state of a smart socket, the strong wind state and sleep state of a smart air purifier, and the cooking state and the warming state of a smart rice cooker, etc. Sometimes, the smart device changes the state by itself. For example, the smart rice cooker automatically turns to warming state after finishing the cooking task.

The server 140 is a device that provides remote control computing service, and may have the functions of receiving instructions, sending instructions, data caching, and deploying services.

The control terminal 160 may be a personal smart terminal, such as a mobile phone, a tablet, and a computer, or may be a remote control device bound to the smart device 120.

The control terminal 160 is bound to the smart device 120. The smart device 120 is connected to the server 140 via Internet or a local area network, and the control terminal 160 is connected to the server 140 via the Internet or the local area network. The control terminal 160 may send control signaling to the server 140, and the server 140 sends a request of a state control that the control signaling wants to implement to the smart device 120, thereby implementing the remote control over the smart device 120 by the control terminal 160.

For example, binding may refer to a binding relationship between the smart device 120 and the control terminal 160 and may also refer to a binding relationship between the smart device 120 and a user account logged in in the control terminal 160. When the control terminal 160 has the binding relationship with the smart device 120, the control terminal 160 has the permission to control the smart device 120.

Referring to FIG. 2, it shows a flowchart of a remote control method for a smart device provide by an aspect of the present disclosure. The following is an example where the remote control method for a smart device is applied to the server 140. The method includes:

In step 201, first control signaling sent by the control terminal for controlling the smart device is received.

Here, the smart device is a device that is bound to the control terminal.

In a possible implementation, the first control signaling is received via Internet or the local area network, and the connection between the control terminal and the server end via the Internet or the local area network may be wired or wireless.

In step 202, a first state parameter indicated by the first control signaling is obtained, and the locally stored current state parameter that the smart device corresponds to is obtained according to the first control signaling. Wherein, the first state parameter may be used to indicate the target state that the control terminal expects the smart device to achieve. Optionally, the first state parameter may be included in the first control signaling, or may be obtained according to the first control signaling. For example, the first control signaling includes the trigger signaling to switch the state, whose value is 0 or 1. If the value is 1, the control terminal expects the smart device to switch its current state. If the value is 0, the control terminal expects the smart device to maintain its current state.

Here, the current state parameter is locally stored at a server end and is used to record a current state of the smart device. For example, the current state parameter is the cached information of the current state of the smart device stored in the server.

Optionally, one or more current state parameters are stored locally in the server.

In a possible implementation, one of the current state parameters corresponds to a type of state of the smart device, for example, the ON state and an OFF state of a smart air conditioner. Another current state parameter corresponds to another type of state of the smart device, for example, the cooling state and heating state of the smart air conditioner.

In another possible implementation, one current state parameter corresponds to multiple types of states of the smart device. For example, the value 0, 1, 2, and 3 of the current state parameter respectively corresponds to the ON and cooling state, the ON and heating state, and the ON and ventilation state, and dormant state of the smart air conditioner.

It can be understood that the state corresponds to the current state parameter may not be consistent with the multiple types of state that the smart device is actually in. The state inconsistency may be caused by the smart device changing its state by itself, and may also be caused by the failure to receive or interpret the control signaling sent by the server to the smart device.

In step 203, when the first state parameter is different from the current state parameter, second control signaling is sent to the smart device.

The second control signaling includes a second state parameter for controlling the smart device to change the current state.

It can be understood that when the first state parameter is the same as the current state parameter, it indicates that the current state of the smart device recognized by the server end is consistent with the state that the control device needs to control, and the second control signaling is not sent to the smart device, thereby saving network overhead and reducing the times to wake the smart device.

In the technical solution provided by the present disclosure, for the received first control signaling sent by the control terminal, when the first state parameter indicated by the first control signaling is different from the locally stored current state parameter that the smart device corresponds to, the second control signaling is sent to the smart device to control the smart device to change its current state, instead of having to send the second control signaling every time the first control signaling is received, thereby effectively reducing the network overhead of signaling transmission.

In addition, the smart device is waken to receive the second control signaling and execute the second control signaling when the first state parameter is different from the locally stored current state parameter that the smart device corresponds to, thereby reducing the times of the smart device being woken and reducing the energy consumption of the smart device.

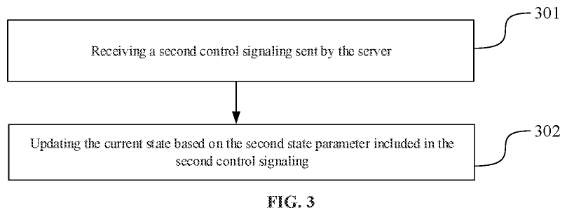

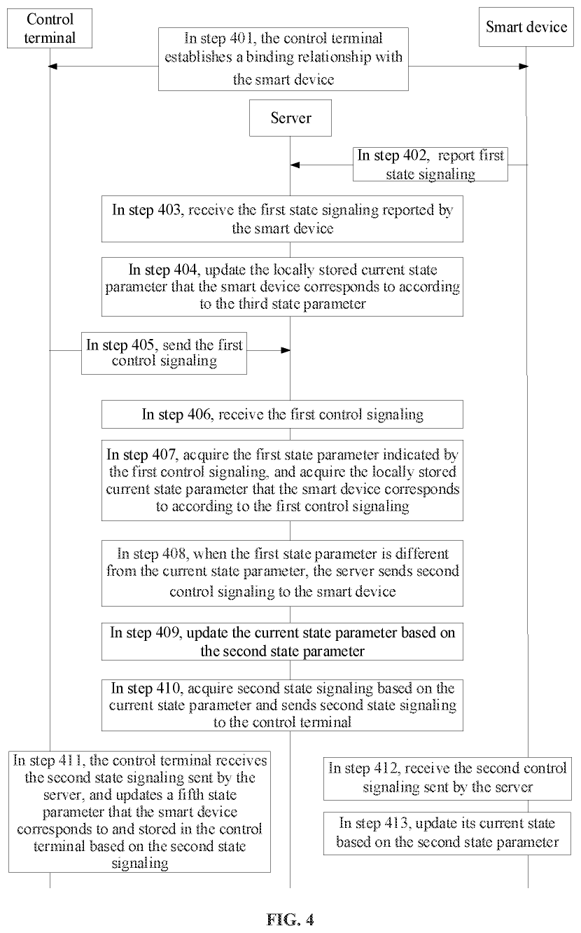

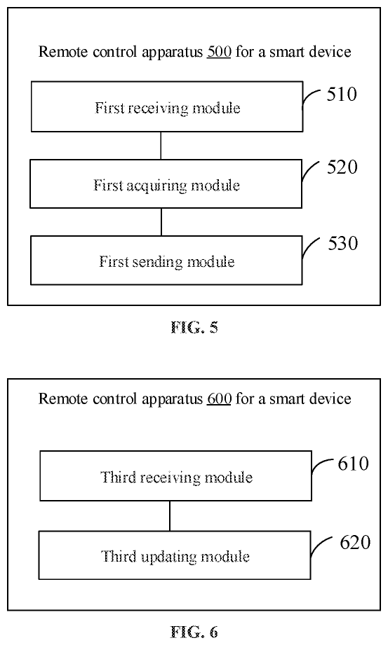

Referring to FIG. 3, it shows a flowchart of a remote control method for a smart device according to an aspect of the present disclosure. The following is an example where the remote control method for a smart device is applied to the smart device 120. The method may include:

In step 301, second control signaling sent by the server is received.

Here, the second control signaling includes a second state parameter for controlling the smart device to change the current state. The second control signaling is sent when the server receives the first control signaling sent by the control terminal and the first state parameter indicated by the first control signaling is different from the current state parameter that the smart device corresponds to. The second state parameter is generated based on the first state parameter. Generally, the value of the second state parameter may be the same as the value of the first state parameter. The current state parameter is a state parameter that is stored locally in the server and the smart device corresponds to. The smart device is a device that is bound to the control terminal.

In step 302, the current state is updated based on the second state parameter included in the second control signaling.

It can be understood that when the second state parameter is the same as the current state of the smart device, the smart device does not need to change its current state.

In the technical solution provided by the present disclosure, for the received first control signaling sent by the control terminal, when the first state parameter indicated by the first control signaling is different from the locally stored current state parameter that the smart device corresponds to, the second control signaling is sent to the smart device to control the smart device to change its current state, instead of having to send the second control signaling each time the first control signaling is received at the server, thereby effectively reducing the network overhead of signaling transmission.

In addition, the smart device is woken to receive the second control signaling and execute the second control signaling when the first state parameter is different from the locally stored current state parameter that the smart device corresponds to, thereby reducing the times of the smart device being woken and reducing the energy consumption of the smart device.

Referring to FIG. 4, it shows a flowchart of a remote control method for a smart device according to an aspect of the present disclosure. The following is an example where the remote control method for a smart device is applied to the remote control system 100 of the smart device. The method includes:

In step 401, the control terminal establishes a binding relationship with the smart device.

Optionally, the control terminal may have the binding relationship with multiple smart devices, that is, control of multiple smart devices can be implemented by the control terminal. The smart device may also have the binding relationship with multiple control terminals, that is, the control of the smart device can be implemented by the multiple control terminals.

Optionally, the control terminal establishes the binding relationship with the smart device by using its loaded application program, and the included steps are as follows:

The binding relationship between the control terminal and the smart device is established by logging in a user account through the application loaded in the control terminal. The user account has a binding relationship with the smart device.

In a possible implementation, the control terminal establishes a binding relationship with the smart device by the server. Exemplarily, step 401 includes:

The smart device sends network data packets, and the control terminal discovers the smart device according to the network data packets by the application program loaded by the control terminal.

The control terminal sends home network account and password that the smart device intends to access the home network with to the smart device through the application program, so that the smart device accesses the home network according to the home network account and the password;

The control terminal sends the user account logged in the control terminal to the smart device through the application program.

The smart device sends a binding request to the server according to the user account logged in in the control terminal and its device identifier.

The server establishes the binding relationship between the smart device and the user account according to the binding request, thereby establishing the binding relationship with the control terminal that is logged in with the user account.

In another possible implementation, the control terminal establishes the binding relationship with the smart device through a user interaction interface included in the control terminal or the smart device.

Exemplarily, the smart device acquires the user account input by the user through the user interaction interface included in the smart device. The smart device establishes the binding relationship with the user account based on the user account, thereby establishing the binding relationship of the control terminal logged in with the user account.

Exemplarily, the control terminal may acquire a list of the smart devices with which it can establish the binding relationship. The control terminal displays the list of the smart devices through the user interaction interface included in the control terminal, and receives an operation of the smart device that the user selects to bind to. The control terminal acquires the device identifier of the smart device to be bound by the received operation of the user selecting the smart device. The control terminal communicates with the smart device based on the device identifier of the smart device to be bound, thereby establishing the binding relationship with the smart device.

It should be noted that step 401 is optional. After the binding relationship between the control terminal and the smart device is established and when the remote control method for a smart device is used to control the smart device, step 401 is not required.

In step 402, the smart device reports first state signaling to the server.

Here, the first state signaling includes a third state parameter. The third state parameter is used to indicate the current state of the smart device, and the server is used to update the locally stored current state parameter that the smart device corresponds to according to the third state parameter.

Optionally, the third state parameter is used to indicate one or more current states of the smart device. For example, the third state parameter may indicate a cooling temperature of the smart air conditioner. The third state parameter may further indicate that the smart device is ON and is in a cooling state, and the cooling temperature is 24 Celsius degree.

In a possible implementation, the smart device reports the first state signaling through the Internet or the local area network. In order to reduce the power consumption of the smart device and the network transmission overhead, step 402 includes:

The smart device reports the first state signaling to the server periodically. Optionally, the period may be configured by the server or the smart device. For example, for the smart air conditioner, the period may be configured to be 30 minutes.

And/or, when the state of the smart device changes, the smart device reports the first state signaling to the server. For example, when the state of the smart air conditioner changes from ON to OFF, the smart air conditioner reports the first state signaling, and the third state parameter included in the first signaling carries the information of the OFF state of the smart air conditioner.

In step 403, the server receives the first state signaling reported by the smart device

In a possible implementation, step 403 includes the following two manners.

Manner 1: the server receives the first state signaling reported periodically by the smart device.

It should be noted that, due to the reasons that the smart device is in a power-off state and the like, the first state signaling may not be reported in the report period, the server may receive the first state signaling in the report period, or may not receive the first state signaling.

Manner 2: the server receives the first state signaling reported by the smart device when the state of the smart device changes.

Optionally, in manner 2, the server may receive the first state signaling by monitoring a specific message channel, wherein the specific message channel may be a specific radio wave frequency or may also be a specific time. The server may also monitor a specific signal, and when the specific signal appears, the server receives the first state signaling.

In step 404, the server updates the locally stored current state parameter that the smart device corresponds to according to the third state parameter.

For example, the third state parameter included in the first state signaling reported by the smart air conditioner is a cooling temperature of 24 Celsius degree, and the server updates the cooling temperature in the current state parameter, that the smart air conditioner corresponds to, to 24 Celsius degree.

In a possible implementation manner, step 404 may include:

The server acquires the device identifier of the smart device. Optionally, the device identifier of the smart device may be acquired through the first state signaling reported by the smart device.

The server acquires the locally stored current state parameter that the smart device corresponds to according to the device identifier of the smart device. For example, in a local storage space of the server, a correspondence table of the device identifier of the smart device and the current state parameter of the smart device is stored. The server may look up the correspondence table to acquire the current state parameter of the smart device according to the device identifier of the smart device;

If the current state parameter that the smart device corresponds to is inconsistent with the third state parameter, the server updates the locally stored current state parameter that the smart device corresponds to according to the third state parameter.

In step 405, the control terminal sends the first control signaling to the server.

The control terminal may send the first control signaling to the server via a wired or wireless network.

In a possible implementation, the control terminal stores the state of the smart device. The state of the smart device is the state of the smart device obtained by the control terminal, which may be different from the actual state of the smart device, and the step 405 may include:

The control terminal acquires a target state that the user expects the smart device to reach through its user interaction interface included in the control terminal.

When the target state acquired by the control terminal is different from the state of the smart device stored in the control terminal, the control terminal generates the first control signaling, wherein the first control signaling indicates a first state parameter, and the first state parameter is used to indicate the target state.

The control terminal sends the first control signaling to the server.

In step 406, the server receives the first control signaling.

Step 406 refers to step 201, and is not repeated herein.

In step 407, the server acquires the first state parameter indicated by the first control signaling, and acquires the locally stored current state parameter that the smart device corresponds to according to the first control signaling.

In a possible implementation, the current state parameter is stored corresponding to the device identifier, and the first control signaling includes the device identifier of the smart device. Step 407 may include:

According to the device identifier of the smart device included in the first control signaling, the locally stored current state parameter that the smart device corresponds to is acquired.

For example, in the local storage space of the server, a correspondence table of the device identifier of the smart device and the current state parameter of the smart device is stored. In the correspondence table, each device identifier of the smart device corresponds to each current state parameter of the smart device. The server may look up the correspondence table to acquire the current state parameter of the smart device according to the device identifier of the smart device included in the first control signaling.

In step 408, when the first state parameter is different from the current state parameter, the server sends second control signaling to the smart device.

Wherein, the second control signaling includes a second state parameter for controlling the smart device to change the current state.

Step 408 refers to step 203, and is not repeated herein.

In step 409, the server updates the current state parameter based on the second state parameter.

In order to ensure that the current state parameter that the smart device responds to and stored locally in the server is consistent with the actual current state of the smart device, to further reduce the network overhead of control signaling caused by the asynchronicity, the server updates the current state parameter based on the second state parameter included in the second control signaling sent to the smart device in step 408.

In a possible implementation, step 409 includes:

In a local storage space of the server, a correspondence table storing the device identifier of the smart device and the current state parameter of the smart device is acquired.

According to the device identifier of the smart device, a value of the current state parameter corresponding to the smart device in the correspondence table is updated to a value of the second state parameter.

It should be noted that, since the smart device may not successfully receive the second control signaling, that is, the current state cannot be updated according to the second state parameter included in the second control signaling, therefore, the condition where the current state parameter that the smart device corresponds to and locally stored in the sever is inconsistent with the actual current state of the smart device may occur. Step 409 is an optimization to further reduce the network overhead and is optional.

In step 410, the server acquires second state signaling based on the current state parameter and sends second state signaling to the control terminal.

Wherein, the second state signaling includes a fourth state parameter, wherein the fourth state parameter is used to update a state parameter that the smart device corresponds to in the control terminal.

In a possible implementation, step 410 may include:

In a local storage space of the server, a correspondence table storing the device identifier of the smart device and the current state parameter of the smart device is acquired.

The correspondence table is looked up to acquire the current state parameter that the smart device corresponds to according to the device identifier of the smart device.

The fourth state parameter is acquired according to the current state parameter that the smart device corresponds to. Optionally, a value of the current state parameter that the smart device corresponds to is assigned to the fourth state parameter.

The second state signaling is acquired based on the fourth state parameter.

The second state signaling is sent to the control terminal.

Optionally, the control terminal is a control terminal bound to the smart device.

It should be noted that step 410 is to send the current state of the smart device acquired by the server to the control terminal as soon as possible, to reduce the probability of sending the first control signaling in step 405. Step 410 is optional.

In step 411, the control terminal receives the second state signaling sent by the server, and updates a fifth state parameter that the smart device corresponds to and stored in the control terminal based on the second state signaling.

In a possible implementation, the fifth state parameter that the smart device corresponds to is stored in the local storage space in the control terminal. The control terminal determines, according to the fifth state parameter, whether it needs to send the control signaling to the smart device.

In step 412, the smart device receives the second control signaling sent by the server.

Wherein, the second control signaling includes a second state parameter for controlling the smart device to change the current state. The second control signaling is sent when the server receives the first control signaling sent by the control terminal and when the first state parameter indicated by the first control signaling is different from the current state parameter that the smart device corresponds to, the current state parameter is a state parameter that the smart device corresponds to and is stored locally in the server, and the smart device is a device that is bound to the control terminal.

Optionally, the smart, device may receive the second control signaling sent by the server via a wired or wireless network.

In step 413, the smart device updates its current state based on the second state parameter.

In a possible implementation, the second state parameter may include one or multiple state information. Step 413 may include:

The smart device parses the second state parameter to acquire one or more target states of the smart device.

The smart device updates its current state based on the one or more target states respectively.

In one example, a value of the second stat parameter is 10. Then, according to the corresponding relationship between the value and the information of the preset second state parameter. The information indicated by the second state parameter is that the on-off state of a smart TV is ON and the downloading state of the software to be updated becomes start downloading. Then the target states of the smart device obtained by the smart TV through parse according to the second state parameter are that the on-off state of the smart. TV is ON, and the downloading state of the software to be updated is start downloading. The smart TV respectively updates its on-off state to ON, and the downloading state of the software to be updated becomes start downloading according to the above two target states.

In the technical solution provided by the present disclosure, for the received first control signaling sent by the control terminal, when the first state parameter indicated by the first control signaling is different from the locally stored current state parameter that the smart device corresponds to, the second control signaling is sent to the smart device to control the smart device to change its current state, instead of sending the second control signaling each time the first control signaling is received, thereby effectively reducing the network overhead of signaling transmission.

In addition, the smart device is woken to receive the second control signaling and execute the second control signaling when the first state parameter is different from the locally stored current state parameter that the smart device corresponds to, thereby reducing the times of the smart device being woken and reducing the energy consumption of the smart device.

The following descriptions are the aspects of the apparatus of the present disclosure. Details which are not fully described in the aspects of the apparatus may refer to the above aspects of the method.

Referring to FIG. 5, it shows a block diagram of a structure of a remote control apparatus 500 for a smart device according to an aspect of the present disclosure. The remote control apparatus 500 for a smart device includes: a first receiving module 510, a first acquiring module 520, and a first sending module 530.

The first receiving module 510 is configured to acquire the first state parameter indicated by the first control signal and acquire the locally stored current state parameter that the smart device corresponds to according to the first control signal.

The first acquiring module 520 is configured to acquire the first state parameter indicated by the first control signaling and acquire the locally stored current state parameter that the smart device corresponds to according to the first control signaling.

The first sending module 530 is configured to send second control signaling to the smart device when the first state parameter is different from the current state parameter.

Here, the second control signaling includes a second state parameter for controlling the smart device to change a current state.

In the technical solution provided by the present disclosure, for the received first control signaling sent by the control terminal, when the first state parameter indicated by the first control signaling is different from the locally stored current state parameter that the smart device corresponds to, the second control signaling is sent to the smart device to control the smart device to change its current state, instead of sending the second control signaling every time the first control signaling is received, thereby effectively reducing the network overhead of signaling transmission,

In addition, the smart device is woken to receive the second control signaling and execute the second control signaling only when the first state parameter is different from the locally stored current state parameter that the smart device corresponds to, thereby reducing the times of the smart device being woken and reducing the energy consumption of the smart device.

In a possible implementation, the current state parameter is stored corresponding to a device identifier; the first control signaling includes the device identifier of the smart device. The first acquiring module 52( )is configured to acquire, based on the device identifier of the smart device included in the first control signaling, the locally stored current state parameter that the smart device corresponds to.

Optionally, the remote control apparatus 500 for a smart device further includes:

a second receiving module configured to receive the first state signaling reported by the smart device,

wherein, the first state signaling includes a third state parameter, and the third state parameter is used to indicate the current state of the smart device; and

a first updating module configured to update the locally stored current state parameter that the smart device corresponds to according to the third state parameter.

In a possible implementation, the second receiving module is configured to receive the first state signaling periodically reported by the smart device; or receive the first state signaling reported by the smart device when the state of the smart device changes.

Optionally, the remote control apparatus 500 for a smart device further includes: a second updating module configured to update the current state parameter based on the second state parameter.

Optionally,the remote control apparatus 500 for a smart device further includes:

a second acquiring module configured to acquire second state signaling based on the current state parameter; and

a second sending module configured to send the second state signaling to the control terminal.

Wherein, the second state signaling includes a fourth state parameter, and the fourth state parameter is used to update a state parameter that the smart device corresponds to in the control terminal.

Referring to FIG, 6, it shows a block diagram of a structure of a remote control apparatus 600 for a smart device according to an aspect of the present disclosure. The remote control apparatus 600 for a smart device includes: a third receiving module 610 and a third updating module 620.

The third receiving module 610 is configured to receive the second control signaling sent by a server.

Wherein, the second control signaling includes a second state parameter for controlling the smart device to change a current state The second control signaling is sent when the server receives the first control signaling sent by the control terminal and a first state parameter indicated by the first control signaling is different from the current state parameter that the smart device corresponds to, the current state parameter is the state parameter locally stored in the server and that the smart device corresponds to, and the smart device is a device bound to the control terminal.

The third updating module 620 is configured to update the current state based on the second state parameter.

In the technical solution provided by the present disclosure, for the received first control signaling sent by the control terminal, when the first state parameter indicated by the first control signaling is different from the locally stored current state parameter that the smart device corresponds to, the second control signaling is sent to the smart device to control the smart device to change its current state, instead of sending the second control signaling every time the first control signaling is received, thereby effectively reducing the network overhead of signaling transmission.

In addition, the smart device needs to be woken to receive the second control signaling and execute the second control signaling only when the first state parameter is different from the locally stored current state parameter that the smart device corresponds to, thereby reducing the times of the smart device being woken and reducing the energy consumption of the smart device.

Optionally, the remote control apparatus 600 for a smart device further includes:

a reporting module configured to report first state signaling to the server.

Wherein, the first state signaling includes a third state parameter, the third state parameter is used to indicate the current state of the smart device, and the server is configured to, according to the third state parameter, update the locally stored current state parameter that the smart device corresponds to.

In a possible implementation, the reporting module is configured to: periodically report the first state signaling to the server; and report the first state signaling to the server when the state of the smart device changes.

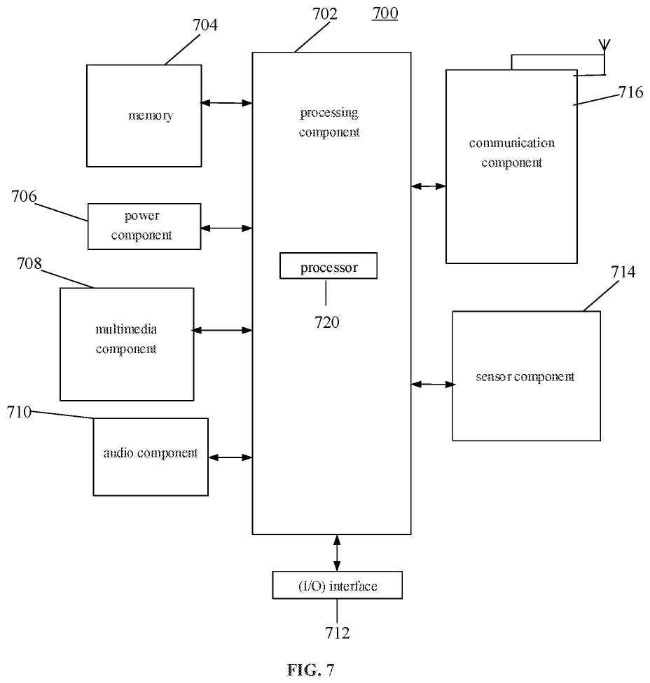

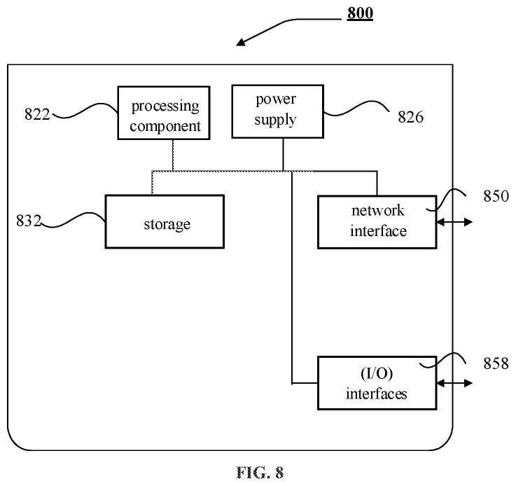

Referring to FIG. 7, it shows a block diagram of a structure of a remote control apparatus for a smart device according to an aspect of the present disclosure. The remote control apparatus 700 for a smart device is the control terminal 120 in FIG. 1.

Referring to FIG. 7, the apparatus 700 may include one or more of the following components: a processing component 702, a memory 704, a power component 706, a multimedia component 708, an audio component 710, an input/output (1/0) interface 712, a sensor component 714, and a communication component 716.

The processing component 702 typically controls overall operations of the apparatus 700, such as the operations associated with display, telephone calls, data communications, camera operations, and recording operations. The processing component 702 may include one or more processors 720 to execute instructions to complete all or part of the steps in the steps described above. In addition, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the apparatus 700. Examples of such data include instructions for any applications or methods operated on the apparatus 700, contact data, phonebook data, messages, pictures, video, etc. The memory 704 may be implemented by any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the apparatus 700. The power component 706 may include a power management system, one or more power sources, and any other components associated with the generation, management, and power distribution in the apparatus 700,

The multimedia component 708 includes a screen providing an output interface between the apparatus 700 and the user. In some aspects, the screen may include a liquid crystal display (LED) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action In some aspects, the multimedia component 708 includes a front camera and/or a rear camera. The front camera and the rear camera may receive an external multimedia data when the apparatus 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone (MIC). The microphone is configured to receive external audio signals when the apparatus 700 is in an operation mode, such as a call mode, a recording mode, and a voice recognition mode. The received audio signals may be further stored in the memory 704 or transmitted via the communication component 716. In some aspects, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a start button, and a lock button.

The sensor component 714 includes one or more sensors to provide status assessments of various aspects of the apparatus 700. For instance, the sensor component 714 may detect an on/off status of the apparatus 700, relative positioning of components, e.g., the display and the keypad, of the apparatus 700, a position change of the apparatus 700 or a component of the apparatus 700, a presence or absence of user contact with the apparatus 700, an orientation or an acceleration/deceleration of the apparatus 700, and a temperature change of the apparatus 700. The sensor component 714 may include a proximity sensor configured to detect the presence of objects nearby without any physical contact. The sensor component 714 may also include a light sensor, such as a CMOS or CCD image sensor, used in imaging applications. In some aspects, the sensor component 714 may also include an accelerometer sensor, a gyroscope sensor, a magnetic sensor, a pressure sensor, or a temperature sensor.

The communication component 716 is configured to facilitate wired or wireless communication between the apparatus 700 and other devices. The apparatus 700 can access a wireless network based on a communication standard, such as WiFi, 2G or 3G, or a combination thereof. In one aspect, the communication component 716 receives broadcast signals or broadcast associated information from an external broadcast management system via a broadcast channel. In one aspect, the communication component 716 further includes a near field communication (NFC) module to facilitate short-range communications.

In exemplary embodiments, the apparatus 700 may be implemented with one or more application specific integrated circuits (ARCO, digital signal processors (DSPs), digital signal processing devices (DSPDs), programmable logic devices (PLDs), field programmable gate arrays (FPGAs), controllers, micro-controllers, microprocessors, or other electronic components, for executing the above-described methods.

In exemplary embodiments, a non-transitory computer-readable storage medium including instructions is also provided, such as the memory 704 including instructions which can be executed by the processor 720 in the apparatus 700, to complete the above-described methods. For example, the non-transitory computer-readable storage medium may be a ROM, a RAM, a CD-ROM, a magnetic tape, a floppy disc, an optical data storage device, and the like,

FIG. 8 shows a block diagram of a remote control apparatus 800 for a smart device according to an example of the present disclosure. The remote control apparatus 700 for a smart device is the server 140 in FIG. 1. Referring to FIG. 8, the apparatus 800 includes a processing component 822, which further includes one or more processors, and a storage resource represented by the storage 832 used to store instructions, such as application programs, executed by the processing component 822. The application programs stored in the storage 832 may include one or more modules. Each module may correspond to a set of instructions. In addition, the processing component 822 is configured to execute instruction for implementing the above-mentioned remote control method for a smart device.

The apparatus 800 may also include a power supply 826 configured to execute the power source management of the apparatus 800, a wired or wireless network interfaces 850 configured to connect apparatus 800 to the network, and an input/output (I/O) interfaces 858. The apparatus 800 may operate the operating system stored in the storage 832 such as Windows Server™, Mac OS X™, Unix™, Linux™, FreeBSD™, or the like.

A non-transitory computer-readable storage medium, when its instructions executed by a processor of the terminal, makes the mobile terminal implement the remote control method for a smart device in the above embodiments.

Other embodiments of the present disclosure will be apparent to those skilled in the art after consideration of the specification and practice of the present disclosure. This application is intended to cover any variations, uses, or adaptations of the invention following the general principles thereof and including such undisclosed common knowledge or customary practice in the art in the present disclosure. It is intended that the specification and examples be considered exemplary only. The true scope and spirit of the present disclosure is indicated by the following claims.

It will be appreciated that the present disclosure is not limited to the exact construction that has been described above and illustrated in the accompanying drawings, and that various modifications and changes can be made within the scope thereof. It is intended that the scope of the present disclosure only be limited by the appended claims.

What is claimed is:

1. A remote control method for a smart device, comprising:
receiving first control signaling sent by a control terminal for controlling the smart device, wherein the smart device is bound to the control terminal;
acquiring a first state parameter indicated by the first control signaling, and acquiring, according to the first control signaling, a locally stored current state parameter that the smart device corresponds to; and
sending second control signaling to the smart device when the first state parameter is different from the current state parameter, wherein the second control signaling comprises a second state parameter for controlling the smart device to change a current state.

2. The method according to claim 1, wherein the current state parameter is stored corresponding to a device identifier; the first control signaling comprises the device identifier of the smart device; and
wherein acquiring, according to the first control signaling, the locally stored current state parameter that the smart device corresponds to comprises:
acquiring, based on the device identifier of the smart device included in the first control signaling, the locally stored current state parameter corresponding to the smart device.

3. The method according to claim 1, further comprising:
receiving the first state signaling reported by the smart device, wherein the first state signaling comprises a third state parameter, and the third state parameter is used to indicate the current state of the smart device; and
updating the locally stored current state parameter that the smart device corresponds to according to the third state parameter.

4. The method according to claim 3, wherein receiving the first state signaling reported by the smart device comprises:
receiving the first state signaling periodically reported by the smart device; or
receiving the first state signaling reported by the smart device when the state of the smart device changes.

5. The method according to claim 1, further comprising:
updating the current state parameter based on the second state parameter.

6. The method according to claim 1, further comprising:
acquiring second state signaling based on the current state parameter; and
sending the second state signaling to the control terminal, wherein the second state signaling comprises a fourth state parameter, and the fourth state parameter is used to update a state parameter that the smart device corresponds to in the control terminal.

7. A remote control system for a smart device, comprising:
a processor; and
a memory for storing executable instructions for the processor;
wherein the processor is configured to:
receive first control signaling sent by a control terminal for controlling the smart device, wherein the smart device is a device bound to the control terminal;
acquire a first state parameter indicated by the first control signaling, and acquire, according to the first control signaling, a locally stored current state parameter that the smart device corresponds to; and
send second control signaling to the smart device when the first state parameter is different from the current state parameter, wherein the second control signaling comprises a second state parameter for controlling the smart device to change a current state.

8. The remote control system according to claim 7, wherein the current state parameter is stored corresponding to a device identifier; the first control signaling comprises the device identifier of the smart device; and the processor is further configured to:
acquire, based on the device identifier of the smart device included in the first control signaling, the locally-stored current state parameter corresponding to the smart device.

9. The remote control system according to claim 7, wherein the processor is further configured to:
receive the first state signaling reported by the smart device, wherein the first state signaling comprises a third state parameter, and the third state parameter is used to indicate the current state of the smart device; and
update the locally stored current state parameter that the smart device corresponds to according to the third state parameter.

10. The remote control system according to claim 9, wherein the processor is further configured to:
receive the first state signaling periodically reported by the smart device; or receive the first state signaling reported by the smart device when the state of the smart device changes.

11. The remote control system according to claim 7, wherein the processor is further configured to:
update the current state parameter based on the second state parameter.

12. The remote control system according to claim 7, wherein the processor is further configured to:
acquire second state signaling based on the current state parameter; and
send the second state signaling to the control terminal, wherein the second state signaling comprises a fourth state parameter, and the fourth state parameter is used to update a state parameter that the smart device corresponds to in the control terminal.

13. The remote control system according to claim 7, further comprising a second processor configured to:
receive second control signaling sent by a server, wherein the second control signaling comprises a second state parameter for controlling the smart device to change a current state, the second control signaling is sent when the server receives the first control signaling sent by the control terminal and a first state parameter indicated by the first control signaling is different from the current state parameter that the smart device corresponds to, wherein the current state parameter is the locally stored state parameter stored in the server locally and corresponding to the smart device, and the smart device is bound to the control terminal; and
update the current state based on the second state parameter.

14. The remote control system according to claim 3, wherein the second processor is further configured to:
report first state signaling to the server, wherein the first state signaling comprises a third state parameter, the third state parameter is used to indicate the current state of the smart device, and the server is configured to, according to the third state parameter, update the locally stored current state parameter corresponding to the smart device.

15. The remote control system according to claim 14, wherein the second processor is further configured to:
periodically report the first state signaling to the server; and
report the first state signaling to the server when the state of the smart device changes.

16. A non-transitory computer-readable storage medium having stored therein instructions that, when executed by a processor, implement a remote control method for a smart device, the method comprising:
receiving first control signaling sent by a control terminal for controlling the smart device, wherein the smart device is a device bound to the control terminal;
acquiring a first state parameter indicated by the first control signaling, and acquiring, according to the first control signaling, a locally stored current state parameter that the smart device corresponds to; and.
sending second control signaling to the smart device when the first state parameter is different from the current state parameter, wherein the second control signaling comprises a second state parameter for controlling the smart device to change a current state.
